(19) United States
(12) Patent Application Publication
(10) Pub. No.: US 2022/0402271 A1
(43) Pub. Date: Dec. 22, 2022

(54) CAP AND INKJET PRINTER INCLUDING THE SAME

(71) Applicant: Roland DG Corporation, Hamamatsu-shi (JP)

(72) Inventors: Yu KAMIYAMA, Hamamatsu-shi (JP); Hisaya MATSUOKA, Hamamatsu-shi (JP); Masaru TAKAHASHI, Hamamatsu-shi (JP)

(21) Appl. No.: 17/838,452

(22) Filed: Jun. 13, 2022

(30) Foreign Application Priority Data
Jun. 17, 2021 (JP) 2021-100914

(51) Int. Cl. B41J 2/165

(52) U.S. Cl. CPC B41J 2/16511

(57) ABSTRACT

A cap includes a holder and a body fitted into the holder. The body covers a nozzle surface such that an enclosed space is defined between the body and the nozzle surface. The holder includes a first side wall extending upward from a first bottom wall and having a frame shape in a plan view, and a protrusion on an inner surface of the first side wall and extending in an up-down direction. The body includes a second side wall extending upward from a second bottom wall and having a frame shape in the plan view, a lip on an upper end of the second side wall and contactable with the nozzle surface, and a recessed groove in an outer surface of the second side wall, extending in the up-down direction, and in engagement with the protrusion.

### CROSS REFERENCE TO RELATED APPLICATIONS

This application claims the benefit of priority to Japanese Patent Application No. 2021-100914 filed on Jun. 17, 2021. The entire contents of this application are incorporated herein by reference.

### BACKGROUND OF THE INVENTION

### 1. Field of the Invention

The present invention relates to caps and inkjet printers including the caps.

### 2. Description of the Related Art

Inkjet printers known in the related art include ink heads each including a plurality of nozzles and a nozzle surface provided with the nozzles, and perform predetermined printing on recording media in an inkjet mode. Such an inkjet printer is provided with a capping unit in order to allow ink to be suitably discharged from the nozzles. The capping unit includes a cap to cover the nozzle surface when no printing is being performed.

The capping unit covers the nozzle surface with the cap so as to define an enclosed space between the cap and the nozzle surface. With the enclosed space defined between the cap and the nozzle surface, driving a suction device (e.g., a suction pump) connected to the cap forces highly viscous ink to be discharged from the nozzles. In other words, the suction device is able to force ink to be discharged from the nozzles. Performing such an operation (which may hereinafter be referred to as a “suction operation”) reduces or eliminates clogging of the nozzles.

Japanese Patent No. 6203977, for example, discloses an inkjet printer configured to raise a cap so as to cover a nozzle surface with the cap. In the example illustrated in Japanese Patent No. 6203977, a constant force is applied from the cap to the nozzle surface. The cap is thus suitably attached to an ink head so as to define an enclosed space between the cap and the nozzle surface.

The cap includes a cap body including a lip that comes into contact with the nozzle surface, and a cap holder holding the cap body. The cap body is made of an elastically deformable material. Pressing the lip against the nozzle surface elastically deforms the lip so as to define an enclosed space between the cap and the nozzle surface. Contact of ink with the cap body over a long period of time may deform the cap body, leading to deflection of the cap body. Deflection of the cap body may create a gap between the lip and the nozzle surface upon contact of the lip with the nozzle surface, resulting in failure to suitably define an enclosed space between the cap and the nozzle surface. In the event of failure to define such an enclosed space, driving a suction device may fail to force ink to be discharged from nozzles. Failing to define such an enclosed space may dry the nozzle surface and/or the nozzles and may thus clog the nozzles with ink.

### SUMMARY OF THE INVENTION

Accordingly, preferred embodiments of the present invention provide caps that are each able to prevent deflection of cap bodies.

A cap according to a preferred embodiment of the present invention is for use in an inkjet printer. The inkjet printer includes a placement table on which a recording medium is to be placed, and an ink head including a plurality of nozzles and a nozzle surface provided with the plurality of nozzles. The nozzles are configured to discharge ink onto the recording medium placed on the placement table. The cap is detachably attachable to the ink head. The cap includes a cap holder including an upwardly facing opening, and a cap body fitted into the cap holder. The cap body includes an upwardly facing opening. The cap body is made of an elastically deformable material. The cap body is configured to cover the nozzle surface such that an enclosed space is defined between the cap body and the nozzle surface. The cap holder includes a first bottom wall, a first side wall extending upward from a peripheral edge of the first bottom wall and having a frame shape in a plan view, a housing space defined by the first bottom wall and the first side wall, the housing space housing the cap body, and at least one protrusion provided on an inner surface of the first side wall and extending in an up-down direction. The cap body includes a second bottom wall, a second side wall extending upward from a peripheral edge of the second bottom wall and having a frame shape in the plan view, a lip provided on an upper end of the second side wall, the lip being able to come into contact with the nozzle surface, and at least one recessed groove provided in an outer surface of the second side wall, extending in the up-down direction, and in engagement with the at least one protrusion.

In a cap according to a preferred embodiment of the present invention, the protrusion of the cap holder is in engagement with the recessed groove of the cap body, with the cap body fitted into the cap holder. Because the protrusion extends in the up-down direction, the recessed groove of the second side wall of the cap body in engagement with the protrusion and a portion of the second side wall located around the recessed groove are prevented from deflecting in a direction toward the first side wall (i.e., from deflecting outward of the cap body). Thus, deflection of the lip provided on the upper end of the second side wall is also prevented, making it possible to maintain the lip in a suitable state. Accordingly, if the second side wall of the cap body comes into contact with ink and undergoes, for example, swelling, deflection of the second side wall would be effectively prevented because the protrusion is in engagement with the recessed groove.

Various preferred embodiments of the present invention provide caps that are able to prevent deflection of cap bodies.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of an inkjet printer according to a preferred embodiment of the present invention.

FIG. 2 is a diagram schematically illustrating an arrangement of components on a lower surface of a carriage according to the present preferred embodiment of the present invention.

FIG. 3 is a front view of a capping unit according to the present preferred embodiment of the present invention and its adjacent components, with caps detached from ink heads.

FIG. 4 is a front view of the capping unit according to the present preferred embodiment of the present invention and its adjacent components, with the caps attached to the ink heads.

FIG. 5 is a plan view of the cap according to the present preferred embodiment of the present invention.

FIG. 6 is a perspective view of the cap according to the present preferred embodiment of the present invention.

FIG. 7 is a perspective view of a cap holder according to the present preferred embodiment of the present invention.

FIG. 8 is a perspective view of a cap body according to the present preferred embodiment of the present invention.

FIG. 9 is a cross-sectional view of the cap taken along the line IX-IX in FIG. 5.

FIG. 10 is a cross-sectional view of the cap taken along the line X-X in FIG. 5.

### DETAILED DESCRIPTION OF THE PREFERRED EMBODIMENTS

Preferred embodiments of the present invention provide caps and inkjet printers (hereinafter each referred to as a “printer”) including the caps, which will be described below with reference to the drawings. The preferred embodiments described below are naturally not intended to limit the present invention in any way. Components or elements having the same functions are identified by the same reference signs, and description thereof will be simplified or omitted when deemed redundant.

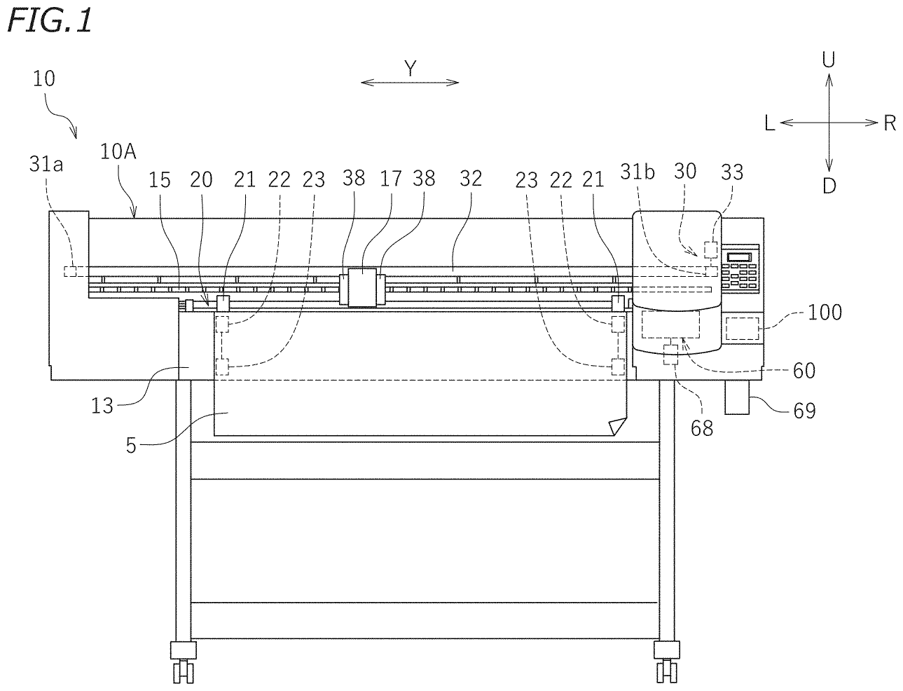

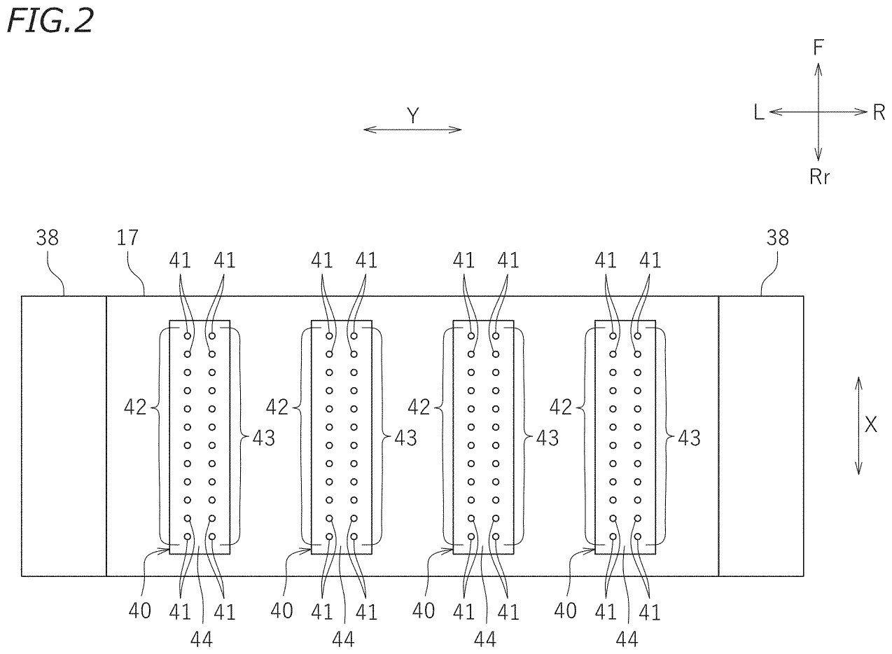

FIG. 1 is a front view of a printer 10 according to the present preferred embodiment. In the following description, the reference signs F, Rr, L, R, U, and D in the drawings respectively represent front, rear, left, right, up, and down when viewed from a position in front of the printer 10. The reference sign “Y” in the drawings represents a main scanning direction. The reference sign “X” (see FIG. 2) in the drawings represents a sub-scanning direction. In the present preferred embodiment, the main scanning direction Y corresponds to a right-left direction, and the sub-scanning direction X corresponds to a front-rear direction. In a plan view, the sub-scanning direction X is perpendicular or substantially perpendicular to the main scanning direction Y. The sub-scanning direction X is an example of a predetermined direction. These directions, however, are defined merely for the sake of convenience of description. These directions do not limit how the printer 10 may be installed or do not limit the present invention in any way.

As illustrated in FIG. 1, the printer 10 performs printing on a recording medium 5. The recording medium 5 is, for example, recording paper. The recording medium 5, however, is not limited to recording paper. Examples of the recording medium 5 include paper, such as plain paper and inkjet printing paper, sheets and films made of resins, such as polyvinyl chloride and polyester, and fabrics, such as a woven fabric and a nonwoven fabric. The recording medium 5 may be any other suitable medium.

As illustrated in FIG. 1, the printer 10 includes a printer body 10A, a platen 13, a guide rail 15, a carriage 17, a conveyor 20, a head mover 30, light applicators 38; ink heads 40 (see FIG. 2), a capping unit 60, and a controller 100.

The printer body 10A includes a casing extending in the main scanning direction Y. The recording medium 5 is placed on the platen 13. The printer 10 performs printing on the recording medium 5 placed on the platen 13. The platen 13 extends in the main scanning direction Y and the sub-scanning direction X. The platen 13 is an example of a placement table.

The conveyor 20 conveys the recording medium 5, which is placed on the platen 13, in the sub-scanning direction X. The conveyor 20 is not limited to any particular configuration, structure, or arrangement. In the present preferred embodiment, the conveyor 20 includes pinch rollers 21, grit rollers 22, and feed motors 23. The pinch rollers 21 are disposed above the platen 13 and below the guide rail 15 so as to press down the recording medium 5 from above. The grit rollers 22 are provided in the platen 13, with upper portions of the grit rollers 22 exposed upward from the platen 13. The grit rollers 22 each face an associated one of the pinch rollers 21. Any suitable number of pinch rollers 21 may be disposed at any suitable locations. Any suitable number of grit rollers 22 may be disposed at any suitable locations. In the present preferred embodiment, a first pair of the pinch roller 21 and the grit roller 22 and a second pair of the pinch roller 21 and the grit roller 22 are respectively disposed adjacent to the right and left ends of the platen 13 as illustrated in FIG. 1.

The grit rollers 22 are each connected with an associated one of the feed motors 23. With the recording medium 5 sandwiched between the pinch rollers 21 and the grit rollers 22, driving the feed motors 23 rotates the grit rollers 22. The rotation of the grit rollers 22 conveys the recording medium 5 in the sub-scanning direction X. The feed motors 23 are controlled by the controller 100.

The guide rail 15 is disposed above the platen 13. The guide rail 15 is disposed in parallel or substantially in parallel with the platen 13. The guide rail 15 extends in the main scanning direction Y. The carriage 17 is in engagement with the guide rail 15. The carriage 17 is slidable along the guide rail 15.

The head mover 30 moves the carriage 17, the ink heads 40 (see FIG. 2), and the light applicators 38 in the main scanning direction Y. The head mover 30 is not limited to any particular configuration, structure, or arrangement. In the present preferred embodiment, the head mover 30 includes a left pulley 31a, a right pulley 31b, a belt 32, and a carriage motor 33. The left pulley 31a is provided in the vicinity of the left end of the guide rail 15. The right pulley 31b is provided in the vicinity of the right end of the guide rail 15. The belt 32 is, for example, an endless belt. The belt 32 is wound around the left pulley 31a and the right pulley 31b. The carriage 17 is secured to the belt 32.

The right pulley 31b is connected with the carriage motor 33. Driving the carriage motor 33 rotates the right pulley 31b so as to cause the belt 32 to run between the left pulley 31a and the right pulley 31b. The running of the belt 32 moves the carriage 17, the ink heads 40, and the light applicators 38 in the main scanning direction Y along the guide rail 15. The carriage motor 33 is controlled by the controller 100.

As illustrated in FIG. 2, the ink heads 40 are mounted on the carriage 17. The ink heads 40 are each longer in the sub-scanning direction X than in the main scanning direction Y. The ink heads 40 are identical in shape and size. The ink heads 40 each include a first nozzle row 42 in which nozzles 41 are aligned in the sub-scanning direction X, a second nozzle row 43 which is located laterally of the first nozzle row 42 and in which the nozzles 41 are aligned in the sub-scanning direction X; and a nozzle surface 44 provided with the nozzles 41. The second nozzle row 43 is located rightward of the first nozzle row 42. Ink (e.g., photo-curable ink) is discharged onto the recording medium 5 from the nozzles 41. The inside of each nozzle 41 is placed under negative pressure (i.e., pressure below atmospheric pressure). Although the number of ink heads 40 included in the printer 10 is four in the present preferred embodiment, the printer 10 may include any other suitable number of ink heads 40. The ink heads 40 each include two nozzle rows. Alternatively, the ink heads 40 may each include a single nozzle row or three or more nozzle rows.

Ink to be discharged from the nozzles 41 of the ink heads is, for example, photo-curable ink. Examples of the photo-curable ink include ultraviolet-curable ink (UV ink). Ultraviolet-curable ink has the property of being cured when irradiated with ultraviolet light.

As illustrated in FIG. 1, one of the light applicators 38 is disposed on the right side of the carriage 17, and the other light applicator 38 is disposed on the left side of the carriage 17. The light applicators 38 each apply light (e.g., ultraviolet light) to the photo-curable ink (e.g., ultraviolet-curable ink) discharged onto the recording medium 5.

The capping unit 60 according to the present preferred embodiment will now be described. The capping unit 60 attaches caps 70 (which will be described below) to the ink heads 40 so as to reduce or prevent drying of the nozzles 41 of the ink heads 40. To reduce or prevent clogging of the nozzles 41, the capping unit 60 forces the ink inside the nozzles 41 to be discharged into the caps 70 by using a suction pump 68 (which will be described below).

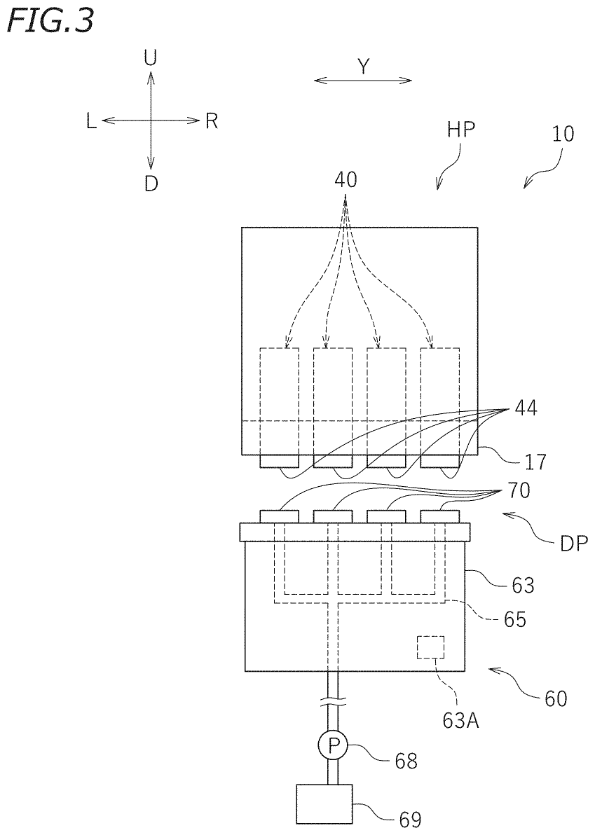

As illustrated in FIG. 1, the capping unit 60 is provided inside the printer body 10A. The capping unit 60 is disposed rightward of the platen 13. As illustrated in FIG. 3, the capping unit 60 includes the caps 70 attachable to and detachable from the ink heads 40, a cap mover 63, and the suction pump 68. In the present preferred embodiment, the number of caps 70 included in the capping unit 60 is four, for example. The caps 70 and the cap mover 63 are disposed at a home position HP located on the right end of the guide rail 15 (see FIG. 1). The home position HP is a position where the carriage 17, the ink heads 40, and the light applicators 38 are put on standby during printing standby (i.e., when no printing is being performed). The home position HP may be any other suitable position. The home position HP may be located on the left end of the guide rail 15.

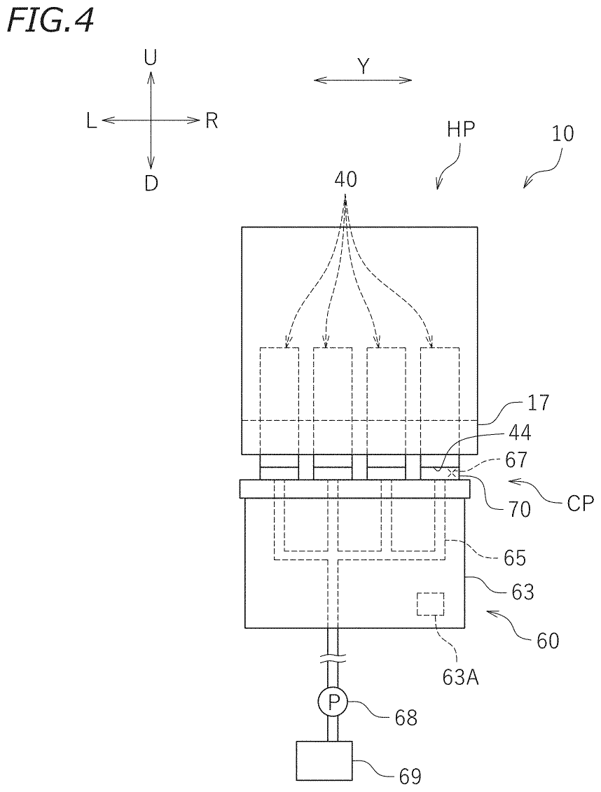

As illustrated in FIG. 3, the cap mover 63 supports the caps 70. The cap mover 63 moves the caps 70 such that the caps 70 are each attachable to and detachable from an associated one of the ink heads 40. In the present preferred embodiment, the cap mover 63 moves the caps 70 in an up-down direction. The cap mover 63 is not limited to any particular configuration, structure, or arrangement. In one example, the cap mover 63 includes a drive motor 63A. The cap mover 63 moves the caps 70 in the up-down direction by driving the drive motor 63A. The cap mover 63 moves the caps 70 upward so as to raise the caps 70 to a capping position CP (see FIG. 4). As used herein, the term “capping position CP” refers to a position where the caps 70 each cover the nozzle surface 44 of the associated ink head 40. Moving the caps 70 to the capping position CP attaches each cap 70 to the associated ink head 40. Attaching the caps 70 to the ink heads 40 defines an enclosed space (see FIG. 4) between each cap 70 and the nozzle surface 44 of the associated ink head 40. When the printer 10 starts printing, the cap mover 63 moves the caps 70 downward so as to lower the caps 70 from the capping position CP (see FIG. 4) to a decapping position DP (see FIG. 3). As used herein, the term “decapping position DP” refers to a position where the caps 70 are each located away from the nozzle surface 44 of the associated ink head 40. Moving the caps 70 to the decapping position DP detaches each cap 70 from the associated ink head 40.

With each cap 70 attached to the associated ink head 40, the suction pump 68 performs a suction operation involving sucking a fluid (e.g., ink) from inside each enclosed space 67 so as to discharge the ink from the nozzles 41 (see FIG. 2). Driving the suction pump 68 places the inside of each enclosed space 67 under pressure below atmospheric pressure (i.e., under negative pressure). This consequently forces the ink to be discharged from the nozzles 41 of the ink heads 40. The suction pump 68 includes a suction port connected to the four caps 70 through a flexible tube 65. The suction pump 68 further includes a discharge port connected to a waste liquid tank 69. The fluid sucked from inside each enclosed space 67 by the suction pump 68 is stored in the waste liquid tank 69. The suction pump 68 is controlled by the controller 100 (see FIG. 1). The suction pump 68 is an example of a suction device.

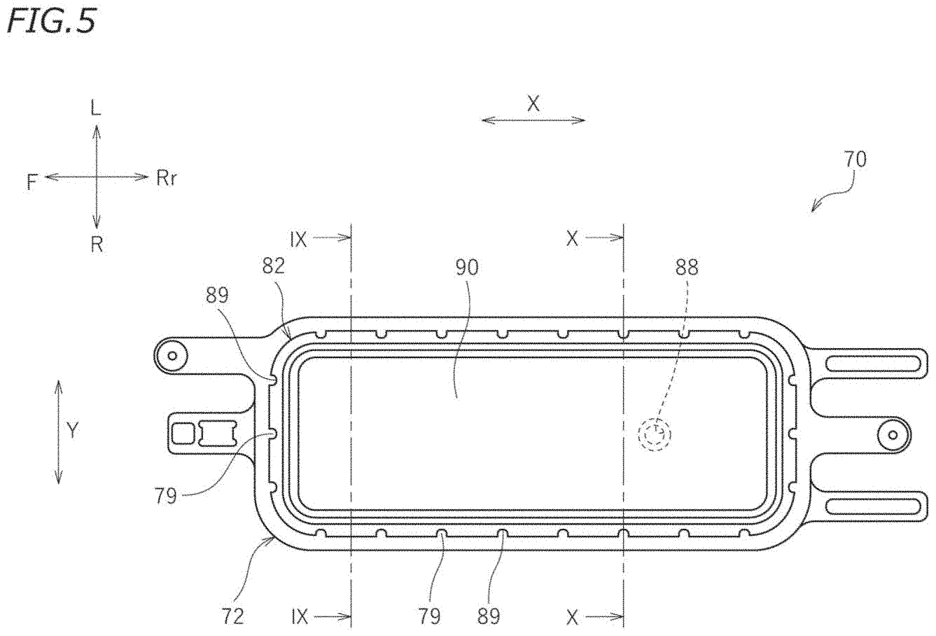

As illustrated in FIG. 3, the caps 70 are in alignment with each other in the main scanning direction Y. As illustrated in FIG. 5, each cap 70 is longer in the sub-scanning direction X than in the main scanning direction Y. The caps 70 are each attachable to the associated ink head 40 such that each cap 70 covers the nozzle surface 44 (see FIG. 2) of the associated ink head 40, and are each detachable from the associated ink head 40 such that the nozzle surface 44 of the associated ink head 40 is uncovered. As used herein, to “cover the nozzle surface 44” does not necessarily refer to covering an entirety of the nozzle surface 44 but may refer to covering at least an entirety of the first nozzle row 42 and an entirety of the second nozzle row 43.

As illustrated in FIG. 5, the caps 70 each include a cap holder 72 including an upwardly facing opening, a cap body 82 fitted into the cap holder 72, and an ink absorber 90 housed in the cap body 82.

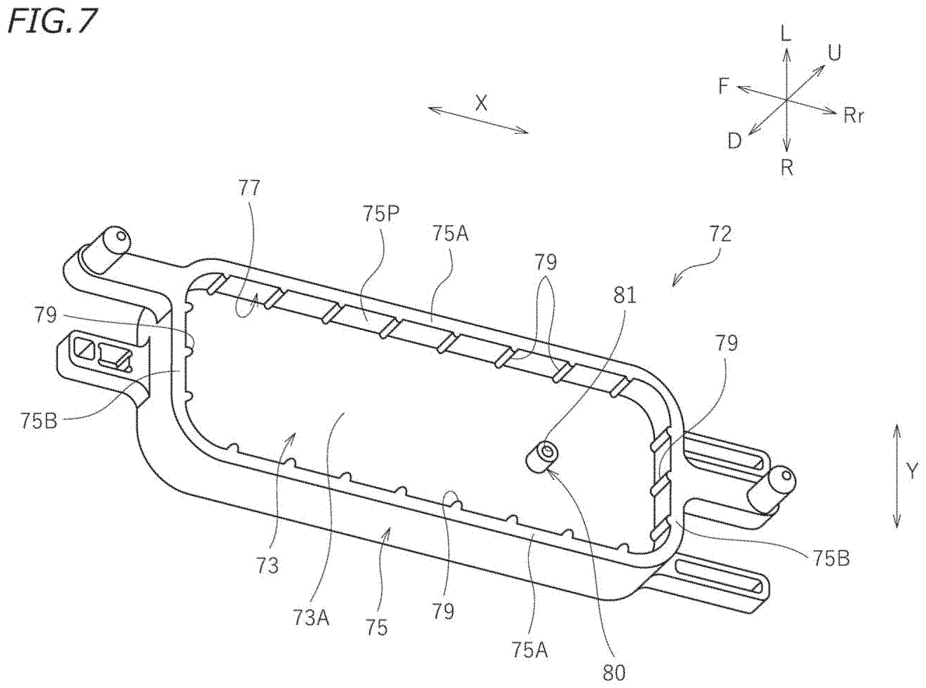

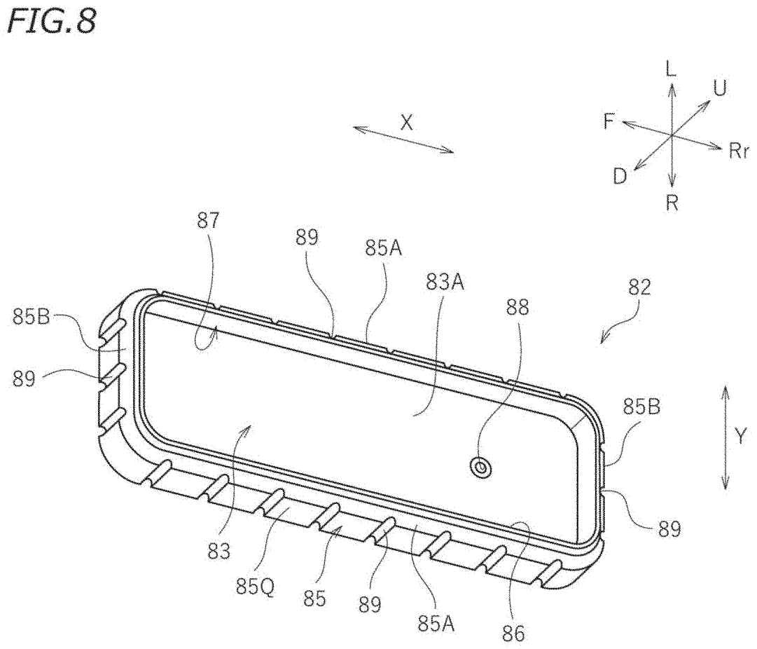

As illustrated in FIG. 7, each cap holder 72 includes a first bottom wall 73, a first side wall 75, a housing space 77, a plurality of protrusions 79, and an ink passage 81. The first bottom wall 73 has a substantially rectangular shape in the plan view. The first side wall 75 extends upward from a peripheral edge of the first bottom wall 73. The first side wall 75 has a substantially rectangular frame shape in the plan view. The first side wall 75 includes a pair of first long sides 75A including straight portions, and a pair of first short sides 75B including straight portions. The first long sides 75A are connected to the first short sides 75B. The first long sides 75A extend in the sub-scanning direction X. The first short sides 75B extend in the main scanning direction Y. The housing space 77 is defined by the first bottom wall 73 and the first side wall 75. The housing space 77 houses the cap body 82 (see FIG. 8). The protrusions 79 are provided on an inner surface 75P of the first side wall 75. The protrusions 79 are provided on the straight portions of the first long sides 75A and the first short sides 75B. No protrusions 79 are provided on curved portions of the first side wall 75. In the present preferred embodiment, the number of protrusions 79 provided on each of the first long sides 75A is eight. The number of protrusions 79 provided on each of the first short sides 75B is three. The protrusions 79 extend in the up-down direction. The protrusions 79 are connected to the first bottom wall 73. The protrusions 79 each extend in a direction away from the inner surface 75P. In one example, the protrusions 79 provided on the left first long side 75A extend toward the right first long side 75A (or extend rightward). The protrusions 79 each have a semicircular shape in the plan view. The first bottom wall 73 includes an upper surface 73A. The upper surface 73A is provided with a boss 80 in which the ink passage 81 is defined. The boss 80 extends upward from the upper surface 73A. The ink passage 81 passes through the first bottom wall 73. The ink passage 81 is connected to the tube 65 (see FIG. 3) in communication with the suction pump 68. Each cap holder 72 is made of a material higher in rigidity than the associated cap body 82. Each cap holder 72 is made of, for example, a resin material (e.g., a polyacetal resin or a polyethylene resin).

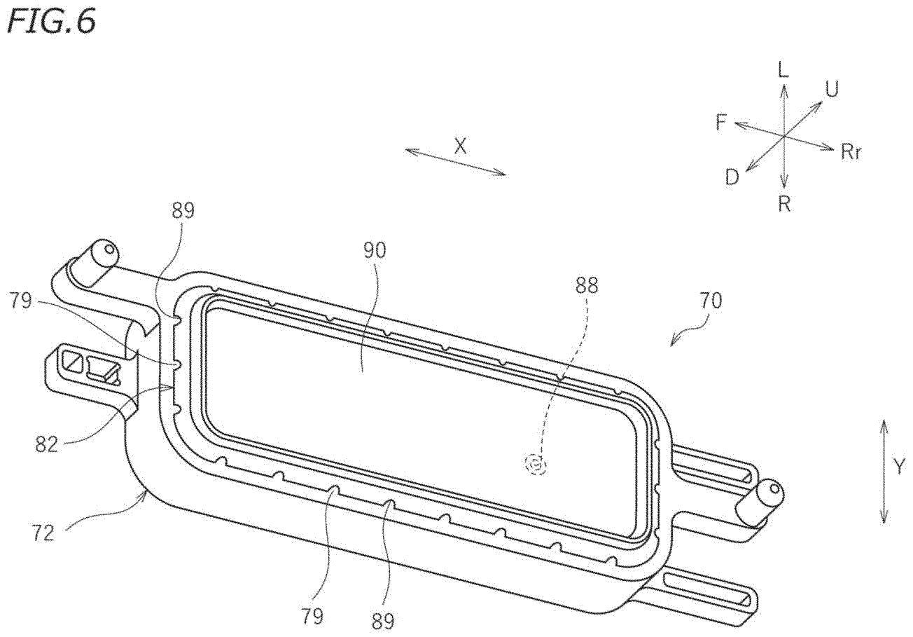

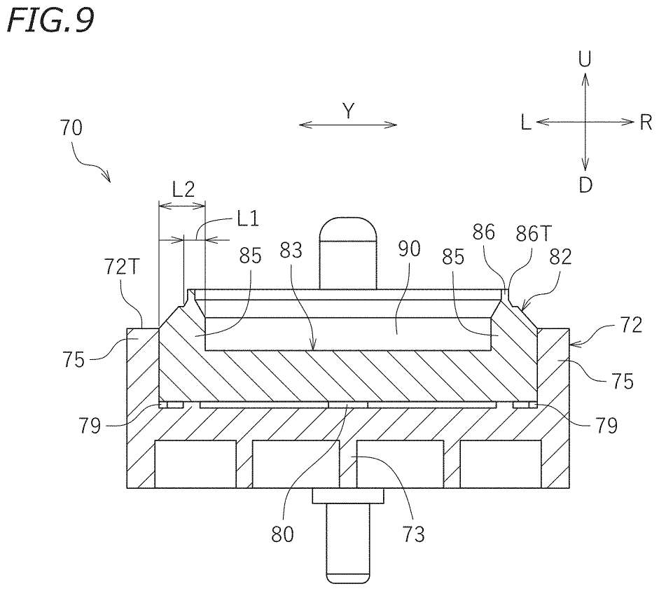

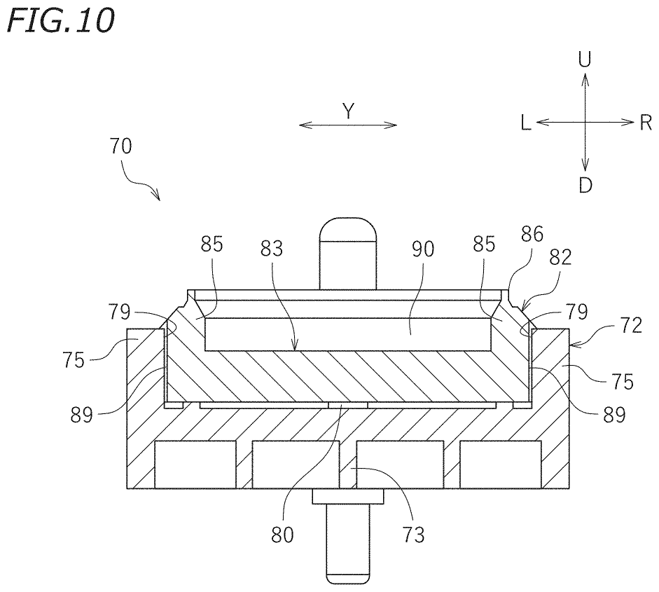

Each cap body 82 is attachable to and detachable from the associated ink head 40. Each cap body 82 covers the nozzle surface 44 of the associated ink head 40 such that the enclosed space 67 (see FIG. 4) is defined between each cap body 82 and the nozzle surface 44 of the associated ink head 40. Each cap body 82 includes an upwardly facing opening. Each cap body 82 is made of an elastically deformable material. Each cap body 82 is made of, for example, rubber. As illustrated in FIG. 8, each cap body 82 includes a second bottom wall 83, a second side wall 85, a lip 86, a housing space 87, and a plurality of recessed grooves 89. The second bottom wall 83 has a substantially rectangular shape in the plan view. The second bottom wall 83 is smaller than the first bottom wall 73 of the cap holder 72. The second side wall 85 extends upward from a peripheral edge of the second bottom wall 83. The second side wall 85 has a substantially rectangular frame shape in the plan view. The second side wall 85 includes a pair of second long sides 85A including straight portions, and a pair of second short sides 85B including straight portions. The second long sides 85A are connected to the second short sides 85B. The second long sides 85A extend in the sub-scanning direction X. The second short sides 85B extend in the main scanning direction Y. As illustrated in FIG. 9, the second side wall 85 is supported by the first side wall 75 of the cap holder 72. The lip 86 is provided on an upper end of the second side wall 85. The lip 86 extends upward from the second side wall 85. The lip 86 is located above an upper end 72T of the cap holder 72. The lip 86 has a substantially rectangular frame shape in the plan view. The lip 86 is able to come into contact with the nozzle surface 44 of the ink head 40. The lip 86 comes into contact with the nozzle surface 44 upon attachment of the cap 70 to the ink head 40. Specifically, with the cap 70 located at the capping position CP (see FIG. 4), the lip 86 is in contact with the nozzle surface 44 such that the lip 86 is pressed against the nozzle surface 44 and elastically deformed. Contact of the lip 86 with the nozzle surface 44 defines the enclosed space 67 between the nozzle surface 44 and the cap body 82. A width L1 (see FIG. 9) of the lip 86 is shorter than a width L2 (see FIG. 9) of the second side wall 85. The housing space 87 is defined by the second bottom wall 83 and the second side wall 85. The housing space 87 houses the ink absorber 90 (see FIG. 6). As illustrated in FIG. 10, the recessed grooves 89 are in engagement with the protrusions 79 of the cap holder 72. The protrusions 79 are fitted into the recessed grooves 89. As illustrated in FIG. 8, the recessed grooves 89 are provided in an outer surface 85Q of the second side wall 85. The recessed grooves 89 are provided in the straight portions of the second long sides 85A and the second short sides 85B. No recessed grooves 89 are provided in curved portions of the second side wall 85. In the present preferred embodiment, the number of recessed grooves 89 provided on each of the second long sides 85A is eight, for example. The number of recessed grooves 89 provided on each of the second short sides 85B is three, for example. The recessed grooves 89 extend in the up-down direction. The recessed grooves 89 are recessed from the outer surface 85Q of the second side wall 85. In one example, the recessed grooves 89 provided on the left second long side 85A are recessed toward the right second long side 85A (or recessed rightward). The recessed grooves 89 each have a semicircular shape in the plan view. The second bottom wall 83 includes an upper surface 83A. The upper surface 83A is provided with a discharge hole 88 into which the boss 80 (see FIG. 7) of the cap holder 72 is to be inserted. The discharge hole 88 is in communication with the suction pump 68 through the ink passage 81 defined in the boss 80. The fluid inside the enclosed space 67 is discharged through the discharge hole 88.

As illustrated in FIG. 5, each ink absorber 90 has a substantially rectangular shape in the plan view. Each ink absorber 90 is housed in the associated cap body 82. Each ink absorber 90 is detachably attached to the associated cap body 82. As illustrated in FIG. 9, each ink absorber 90 is located below an upper end 86T of the associated lip 86. Each ink absorber 90 absorbs the ink discharged from the nozzles 41 of the associated ink head 40. Each ink absorber 90 is porous. Each ink absorber 90 is, for example, a sponge made of polyvinyl alcohol (which may be referred to as a “PVA sponge”).

In each of the caps 70 according to the present preferred embodiment, the protrusions 79 of the cap holder 72 are in engagement with the recessed grooves 89 of the cap body 82, with the cap body 82 fitted into the cap holder 72. Because the protrusions 79 extend in the up-down direction, the recessed grooves 89 of the second side wall 85 of the cap body 82 in engagement with the protrusions 79 and portions of the second side wall 85 located around the recessed grooves 89 are prevented from deflecting in a direction toward the first side wall 75 (i.e., from deflecting outward of the cap body 82). Thus, deflection of the lip 86 provided on the upper end of the second side wall 85 is also prevented, making it possible to maintain the lip 86 in a suitable state. Accordingly, if the second side wall 85 of the cap body 82 comes into contact with ink and undergoes, for example, swelling, deflection of the second side wall 85 would be effectively prevented because the protrusions 79 are in engagement with the recessed grooves 89.

In each of the caps 70 according to the present preferred embodiment, the first side wall 75 has a substantially rectangular frame shape in the plan view and includes the first long sides 75A each including a straight portion and the first short sides 75B each including a straight portion. At least the first long sides 75A are each provided with more than one protrusion 79. The second side wall 85 has a substantially rectangular frame shape in the plan view and includes the second long sides 85A each including a straight portion and the second short sides 85B each including a straight portion. At least the second long sides 85A are each provided with more than one recessed groove 89. The second long sides 85A of the second side wall 85, which has a substantially rectangular frame shape, are likely to deflect. The present preferred embodiment, however, involves providing more than one recessed groove 89 (which comes into engagement with the associated protrusion 79) on each of the second long sides 85A so as to effectively prevent deflection of the second long sides 85A.

In each of the caps 70 according to the present preferred embodiment, the first short sides 75B are each provided with more than one protrusion 79, and the second short sides 85B are each provided with more than one recessed groove 89. This configuration effectively prevents deflection of the second short sides 85B of the second side wall 85.

In each of the caps 70 according to the present preferred embodiment, the recessed grooves 89 each have a semicircular shape in the plan view. Accordingly, if swelling of the second side wall 85 caused by contact with ink, for example, brings the recessed grooves 89 into intimate contact with the protrusions 79, the resulting loads would be distributed through the semicircular recessed grooves 89.

In each of the caps 70 according to the present preferred embodiment, the recessed grooves 89 may each have a polygonal shape in the plan view. Accordingly, if swelling of the second side wall 85 caused by contact with ink, for example, brings the recessed grooves 89 into intimate contact with the protrusions 79, the resulting loads would be distributed through the polygonal recessed grooves 89.

In each of the caps 70 according to the present preferred embodiment, the protrusions 79 are each provided along an entirety of a length of the inner surface 75P of the first side wall 75 in the up-down direction, and the recessed grooves 89 are each provided along an entirety of a length of the outer surface 85Q of the second side wall 85 in the up-down direction. The present preferred embodiment thus more effectively prevents outward deflection of the cap body 82.

Preferred embodiments of the present invention has been described thus far. The preferred embodiments described above, however, are merely illustrative. The present invention may be embodied in various other forms.

In the above-described preferred embodiments, the protrusions 79 and the recessed grooves 89 each have a semicircular shape in the plan view. Alternatively, the protrusions 79 and the recessed grooves 89 may each have any other suitable shape in the plan view. In one example, the protrusions 79 and the recessed grooves 89 may each have a rectangular shape (such as a square shape or an oblong shape), a triangular shape, or a trapezoidal shape in the plan view. When the protrusions 79 and the recessed grooves 89 each have a rectangular shape, a triangular shape, or a trapezoidal shape in the plan view, the vertexes of these shapes (i.e., the points of intersection of sides of these shapes) are preferably chamfered.

In the above-described preferred embodiments, the protrusions 79 are each provided along an entirety of a length of the first side wall 75 in the up-down direction. Alternatively, the protrusions 79 may each be provided along a portion of a length of the first side wall 75 in the up-down direction or may each be divided into a plurality of segments in the up-down direction. In such cases, the recessed grooves 89 may each be provided along a portion of a length of the second side wall 85 in the up-down direction in conformity with the protrusions 79 of the first side wall 75, or may each be provided along an entirety of a length of the second side wall 85 in the up-down direction. In other words, the recessed grooves 89 may each be provided in a portion of the second side wall 85 into which the associated protrusion 79 is to be fitted such that a length of each recessed groove 89 in the up-down direction is equal to or longer than a length of the associated protrusion 79 in the up-down direction. The cap body 82 is made of an elastically deformable material. Accordingly, if each recessed groove 89 is not provided along an entirety of a length of the second side wall 85 in the up-down direction, providing the recessed grooves 89 in conformity with the protrusions 79 makes it possible to insert the cap body 82 into the cap holder 72 while elastically deforming the cap body 82, thus attaching the cap body 82 to the cap holder 72.

In the above-described preferred embodiments, the printer 10 includes the platen 13 on which the recording medium 5 is to be placed and convey the recording medium 5 in the sub-scanning direction X by using the grit rollers 22. The printer 10, however, is not limited to this configuration. The printer 10 may be, for example, a “flatbed printer”. Alternatively, the printer 10 may include a table that is able to move the recording medium 5 in the main scanning direction Y and the sub-scanning direction X.

In the above-described preferred embodiments, the cap mover 63 is configured to move the caps 70 upward and downward. The cap mover 63, however, is not limited to this configuration. In one example, the printer 10 may include a mover to move the carriage 17 or the ink heads 40 upward and downward, with the position of each cap 70 being immovable in the up-down direction.

The terms and expressions used herein are for description only and are not to be interpreted in a limited sense. These terms and expressions should be recognized as not excluding any equivalents to the elements shown and described herein and as allowing any modifications encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A cap for use in an inkjet printer, the inkjet printer including a placement table on which a recording medium is to be placed and an ink head including a plurality of nozzles and a nozzle surface provided with the plurality of nozzles, the nozzles being configured to discharge ink onto the recording medium placed on the placement table, the cap being detachably attachable to the ink head, the cap comprising:
a cap holder including an upwardly facing opening; and
a cap body fitted into the cap holder, the cap body including an upwardly facing opening, the cap body being made of an elastically deformable material, the cap body being structured to cover the nozzle surface such that an enclosed space is defined between the cap body and the nozzle surface; wherein
the cap holder includes:
a first bottom wall;
a first side wall extending upward from a peripheral edge of the first bottom wall and having a frame shape in a plan view;
a housing space defined by the first bottom wall and the first side wall, the housing space housing the cap body; and
at least one protrusion on an inner surface of the first side wall and extending in an up-down direction; and
the cap body includes:
a second bottom wall;
a second side wall extending upward from a peripheral edge of the second bottom wall and having a frame shape in the plan view;
a lip on an upper end of the second side wall, the lip being able to come into contact with the nozzle surface; and
at least one recessed groove in an outer surface of the second side wall, extending in the up-down direction, and in engagement with the at least one protrusion.

2. The cap according to claim 1, wherein
the first side wall has a substantially rectangular frame shape in the plan view, the first side wall including:
a first long side including a straight portion; and
a first short side including a straight portion;
the at least one protrusion includes a plurality of protrusions;
at least the first long side includes the plurality of protrusions;
the second side wall has a substantially rectangular frame shape in the plan view, the second side wall including:
a second long side including a straight portion; and
a second short side including a straight portion;
the at least one recessed groove includes a plurality of recessed grooves; and
at least the second long side is provided with the plurality of recessed grooves.

3. The cap according to claim 2, wherein
the first short side is provided with the plurality of protrusions; and
the second short side is provided with the plurality of recessed grooves.

4. The cap according to claim 1, wherein the at least one recessed groove has a semicircular shape in the plan view.

5. The cap according to claim 1, wherein the at least one recessed groove has a polygonal shape in the plan view.

6. The cap according to claim 1, wherein
the at least one protrusion is provided along an entirety of a length of the inner surface of the first side wall in the up-down direction; and
the at least one recessed groove is provided along an entirety of a length of the outer surface of the second side wall in the up-down direction.

7. An inkjet printer comprising:
the cap according to claim 1;
the placement table;
the ink head; and
a mover to move the cap at least in the up-down direction so as to move the cap between a capping position where the cap covers the nozzle surface and a decapping position where the cap is located away from the nozzle surface.
